(19) United States
(12) Patent Application Publication
(10) Pub. No.: US 2025/0045813 A1
(43) Pub. Date: Feb. 6, 2025

(54) SYSTEMS AND METHODS FOR REAL-TIME SUBSTITUTION

(71) Applicant: Walmart Apollo, LLC, Bentonville, AR (US)

(72) Inventors: Heather Fox Bowen, Encinitas, CA (US); Sri Kanya Mullapudi, Pleasanton, CA (US); Aarish Ramesh, Bangalore (IN); Anantha Raman Lakshmi Narayanan, Bentonville, AR (US)

(21) Appl. No.: 18/476,164

(22) Filed: Sep. 27, 2023

(30) Foreign Application Priority Data
Aug. 3, 2023 (IN) 202341052162

(51) Int. Cl. G06Q 30/0601; G06Q 10/0875

(52) U.S. Cl. CPC G06Q 30/0635; G06Q 10/0875

(57) ABSTRACT

Systems and methods for distributed order fulfillment are disclosed. Real-time fulfillment data indicating unavailability of a first item identified in an order is received from a first computing device. The real-time fulfillment data is generated in response to an input received by the first computing device. Order update data indicating unavailability of the first item and one or more substitute items is transmitted to a second computing device. The order update data causes the second computing device to generate an interface including the substitute items and a portion of the order update data. A substitute response from the second computing device. In response to receiving the substitute response, The selected substitute item is substituted in place of the first item during fulfillment when the substitute response indicates acceptance the substitute item and the first item is removed from the order when the substitute response indicates rejection of the substitute items.

### CROSS-REFERENCE TO RELATED APPLICATION

This application claims benefit to Indian Application No. 202341052162, filed on 3-8-2023, entitled “Systems and Methods for Real-Time Substitution.”

### TECHNICAL FIELD

This application relates generally to generation of real-time user interfaces, and more particularly, to generation of real-time interfaces for distributed fulfillment systems.

### BACKGROUND

Some current systems enable a user to generate an order that is to be fulfilled at a remote location by an individual other than the user. For example, in an e-commerce environment, a user may generate an order to be fulfilled at a fulfillment location such as a retail store or warehouse. During fulfillment of an order, an item selected by a user may not be available, for example, due to low or no inventory, misplaced items, etc. Current fulfillment processes allow for substitution of an item selected by a user without initial input from the user.

Some current systems provide a summary of substituted items after fulfillment of an order has been completed. Although such summaries allow a user to see substitutions, the summaries are provided at a time when approval, rejection, or replacement of a substitute item is difficult. In addition, if a user rejects a substituted item after fulfillment has completed, additional resources must be devoted to removing the substituted item from the fulfilled order, returning the substituted item to a storage location, and/or modifying the order to accommodate the removal of the substitute item.

### SUMMARY

In various embodiments, a system including a non-transitory memory and a processor communicatively coupled to the non-transitory memory is disclosed. The processor is configured to read a set of instructions to receive real-time fulfillment data indicating selection of a substitute item for a first item identified in an order from a first computing device. The real-time fulfillment data is generated in response to selection of the substitute item. The processor is further configured to read the set of instructions to transmit order update data indicating selection of the substitute item to a second computing device. The order update data includes at least a portion of the fulfillment data and the order update data causes the second computing device to generate an interface including at least a portion of the order update data. The processor is further configured to read the set of instructions to receive an approval response from the second computing device and, in response to receiving the approval response, generate fulfillment update data indicating the substituted item was accepted when the approval response indicates an approval of the substitute item and generate fulfillment update data configured to facilitate removal of the substitute item from the order when the approval response indicates a rejection of the substitute item.

In various embodiments, a computer-implemented method is disclosed. The computer-implemented method includes a step of receiving real-time fulfillment data indicating selection of a substitute item for a first item identified in an order from a first computing device. The real-time fulfillment data is generated in response to selection of the substitute item. The computer-implemented method further includes a step of transmitting order update data indicating selection of the substitute item to a second computing device. The order update data includes at least a portion of the fulfillment data and the order update data causes the second computing device to generate an interface including at least a portion of the order update data. The computer-implemented method further includes steps of receiving an approval response from the second computing device and, in response to receiving the approval response, generating fulfillment update data indicating the substituted item was accepted when the approval response indicates an approval of the substitute item and generating fulfillment update data configured to facilitate removal of the substitute item from the order when the approval response indicates a rejection of the substitute item.

In various embodiments, a non-transitory computer readable medium having instructions stored thereon is disclosed. The instructions, when executed by at least one processor, cause at least one device to perform operations comprising receiving real-time fulfillment data indicating selection of a substitute item for a first item identified in an order from a first computing device. The real-time fulfillment data is generated in response to selection of the substitute item. The instructions further cause the at least one device to perform operations including transmitting order update data indicating selection of the substitute item to a second computing device. The order update data includes at least a portion of the fulfillment data and the order update data causes the second computing device to generate an interface including at least a portion of the order update data. The instructions further cause the at least one device to perform operations including receiving an approval response from the second computing device and, in response to receiving the approval response, generating fulfillment update data indicating the substituted item was accepted when the approval response indicates an approval of the substitute item and generating fulfillment update data configured to facilitate removal of the substitute item from the order when the approval response indicates a rejection of the substitute item.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide real-time interactions for distributed fulfillment systems, in accordance with some embodiments;

FIG. 2 illustrates a computer system configured to implement one or more processes, in accordance with some embodiments;

FIG. 3 is a flowchart illustrating a distributed fulfillment method, in accordance with some embodiments;

FIG. 4 is a process flow illustrating various steps of the distributed fulfillment method of FIG. 3, in accordance with some embodiments;

FIG. 5 is a flowchart illustrating an order application workflow, in accordance with some embodiments;

FIGS. 6A-6I illustrate a series of order application interfaces generated during one or more steps of a distributed fulfillment method, in accordance with some embodiments;

FIG. 7 is a flowchart illustrating a fulfillment application workflow, in accordance with some embodiments;

FIGS. 8A-8N illustrate a series of fulfillment application interfaces generated during one or more steps of a distributed fulfillment method, in accordance with some embodiments;

FIG. 9 illustrates a substitution and order fulfillment architecture, in accordance with some embodiments.

FIG. 10 illustrates an artificial neural network, in accordance with some embodiments;

FIG. 11 illustrates a tree-based artificial neural network, in accordance with some embodiments;

FIG. 12 illustrates a deep neural network (DNN), in accordance with some embodiments;

FIG. 13 is a flowchart illustrating a training method for generating a trained machine learning model, in accordance with some embodiments; and

FIG. 14 is a process flow illustrating various steps of the training method of FIG. 13, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for a distributed fulfillment system. In various embodiments, a distributed fulfillment system ingests order information and coordinates interactions between multiple devices in a distributed fulfillment system based on shared data. The distributed fulfillment system may be configured to ingest order data such as initial order data for receiving an order, catalog data related to items selected and/or selectable for inclusion in an order, substitution data related to one or more substitutes selected for one or more items or elements identified in the initial order data, fulfillment data related to current fulfillment status of an order and/or items in an order, and/or interaction data related to one or more interactions facilitated by at least one of the multiple devices in the distributed fulfillment system. The coordinated interactions may include generation, selection, approval, rejection, etc. of one or more substitute items selected for items identified in the initial order data.

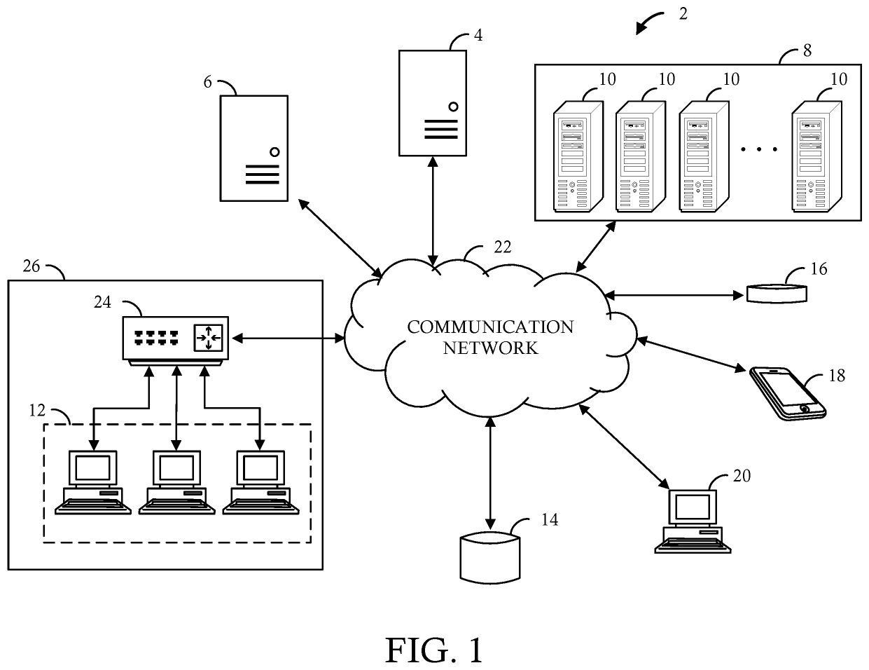

FIG. 1 illustrates a network environment 2 configured to provide distributed fulfillment processes, in accordance with some embodiments. The network environment 2 includes a plurality of devices or systems configured to communicate over one or more network channels, illustrated as a network cloud 22. For example, in various embodiments, the network environment 2 may include, but is not limited to, a fulfillment orchestration computing device 4, a web server 6, a cloud-based engine 8 including one or more processing devices 10, workstation(s) 12, a database 14, and/or one or more distributed computing devices 16, 18, 20 operatively coupled over the network 22. The fulfillment orchestration computing device 4, the web server 6, the processing device(s) 10, the workstation(s) 12, and/or the distributed computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the fulfillment orchestration computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the fulfillment orchestration computing device 4.

In some embodiments, each of the distributed computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the fulfillment orchestration computing device 4, the processing devices 10, and/or the web server 6 are operated by the network environment provider, and the distributed computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the fulfillment orchestration computing device 4, for example. The workstation(s) 12 may communicate with the fulfillment orchestration computing device 4 over the communication network 22. The workstation(s) 12 may send data to, and receive data from, the fulfillment orchestration computing device 4. For example, the workstation(s) 12 may transmit data related to tracked operations performed at the physical location 26 to fulfillment orchestration computing device 4.

Although FIG. 1 illustrates three distributed computing devices 16, 18, 20, the network environment 2 may include any number of distributed computing devices 16, 18, 20. Similarly, the network environment 2 may include any number of the fulfillment orchestration computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the fulfillment orchestration computing device 4, the web server 6, the workstation(s) 12, the database 14, the distributed computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the first distributed computing device 16, the second distributed computing device 18, and the Nth distributed computing device 20 may communicate with the web server 6 over the communication network 22. For example, each of the distributed computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the distributed computing devices 16, 18, 20 to initiate a web browser that is directed to the website hosted by the web server 6. The user may, via the web browser, perform various operations such as searching one or more databases or catalogs associated with the displayed website, view item data for elements associated with and displayed on the website, and click on interface elements presented via the website, for example, in the search results. The website may capture these activities as user session data, and transmit the user session data to the fulfillment orchestration computing device 4 over the communication network 22. The website may also allow the user to interact with one or more of interface elements to perform specific operations, such as selecting one or more items for further processing. In some embodiments, the web server 6 transmits user interaction data identifying interactions between the user and the website to the fulfillment orchestration computing device 4.

In some embodiments, the fulfillment orchestration computing device 4 may execute one or more models, processes, or algorithms, such as a machine learning model, deep learning model, statistical model, etc., to generate substitute recommendations and/or convert data into suitable formats for use by at least one of the distributed computing devices 16, 18, 20. The fulfillment orchestration computing device 4 may transmit application-specific formatted data to the web server 6 and/or at least one of the distributed computing devices 16, 18, 20 over the communication network 22, and the web server 6 and/or the at least one distributed computing devices 16, 18, 20 may display interface elements associated with the distributed fulfillment process on the website to the user. For example, the web server 6 and/or the distributed computing device 16, 18, 20 may display interface elements associated with substitute selection to a user on a rendered substitute selection interface. The substitute selection interface may include a standalone interface and/or may be incorporated into an order fulfillment interface.

In some embodiments, a user interacts with a first distributed computing device 16 to search for items and/or elements stored in an electronic catalog associated with a network provider. The first distributed computing device 16 may receive inputs indicating a preferred item and/or element and, in some embodiments, one or more acceptable substitutes for the preferred item. The first distributed computing device 16 may send an initial order request to the fulfillment orchestration computing device 4. In response to receiving the initial order request, the fulfillment orchestration computing device 4 may execute one or more processes to select a second distributed computing device 18 to associate with fulfillment of the order embodied in the initial order request. The fulfillment orchestration computing device 4 may extract order data from the initial order request and/or obtain additional order and/or item data from additional data sources. The fulfillment orchestration computing device 4 transforms (e.g., convert) the order data into a format expected by an order fulfillment application executable by the second distributed computing device 18 and transmits the transformed order data to the second distributed computing device 18.

In some embodiments, the order fulfillment application is executed to receive fulfillment input data regarding the status of order fulfillment for each item included in an order. For example, in some embodiments, the order fulfillment application is configured to receive and/or generate input data including location data associated with the second distributed computing device 18, item availability data for each item in the order data, item substitution data for a substitute item selected for substitution, item fulfillment data indicating fulfillment of an item, order status data indicating a current status of an order, etc. In some embodiments, the second distributed computing device 18 provides fulfillment input data to the fulfillment orchestration computing device 4 for further processing. For example, in some embodiments, the fulfillment orchestrating computing device 4 is configured to extract relevant portions of the fulfillment input data, transform the relevant portions, and transmit the relevant portions of the fulfillment input data to a order tracking application executable by the first distributed computing device 16.

In some embodiments, the fulfillment orchestration computing device 4 is configured to facilitate a distributed fulfillment process that enables generation of an order via a first distributed computing device 16, fulfillment of the order at a location remote from the first distributed computing device 16 including identification of fulfilled, substituted, and/or unavailable items via a second distributed computing device 18, approval and/or rejection of selected substitute items or selection of substitute items for unavailable items via the first distributed computing device 16 in real-time or near real-time during generation of fulfillment data by the second distributed computing device 18, and tracking of order status via the first distributed computing device 16 in real-time and/or near real-time. As discussed in greater detail below, the fulfillment orchestration computing device 4 enables distributed processing and modification of a received order in near real-time.

The fulfillment orchestration computing device 4 is further operable to communicate with the database 14 over the communication network 22. For example, the fulfillment orchestration computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the fulfillment orchestration computing device 4, in some embodiments, the database 14 may be a local storage device, such as a hard drive, a non-volatile memory, or a USB stick. The fulfillment orchestration computing device 4 may store interaction data received from the web server 6 in the database 14. The fulfillment orchestration computing device 4 may also receive from the web server 6 user session data identifying events associated with browsing sessions, and may store the user session data in the database 14.

In some embodiments, the fulfillment orchestration computing device 4 generates training data for a plurality of models (e.g., machine learning models, deep learning models, statistical models, algorithms, etc.) based on aggregation data, variant-level data, holiday and event data, recall data, historical user session data, search data, purchase data, catalog data, advertisement data for the users, etc. The fulfillment orchestration computing device 4 and/or one or more of the processing devices 10 may train one or more models based on corresponding training data. The fulfillment orchestration computing device 4 may store the models in a database, such as in the database 14 (e.g., a cloud storage database).

In some embodiments, the fulfillment orchestration computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, fulfillment orchestration computing device 4 may generate substitute recommendations and/or transformed data.

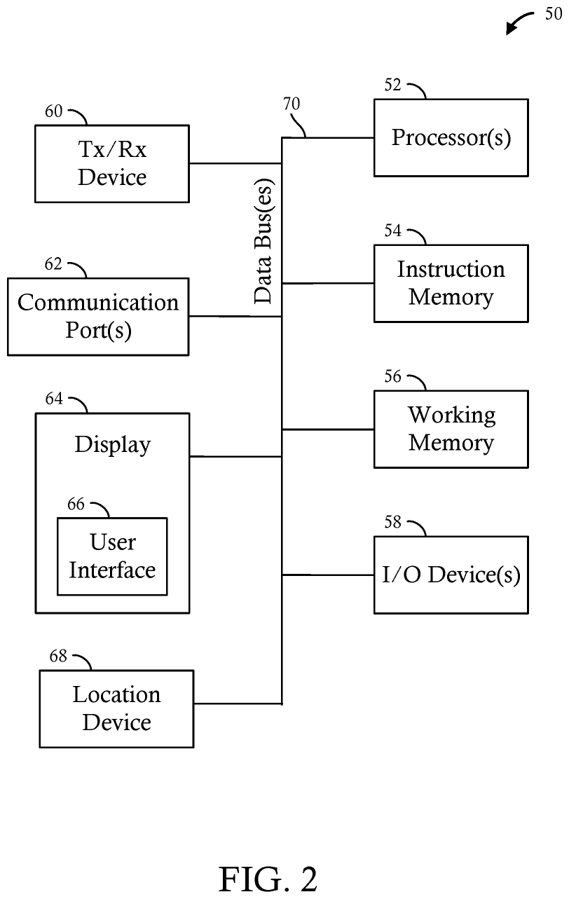

FIG. 2 illustrates a block diagram of a computing device 50, in accordance with some embodiments. In some embodiments, each of the fulfillment orchestration computing device 4, the web server 6, the one or more processing devices 10, the workstation(s) 12, and/or the distributed computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™ Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for distributed fulfillment, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with distributed fulfillment applications. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to the a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

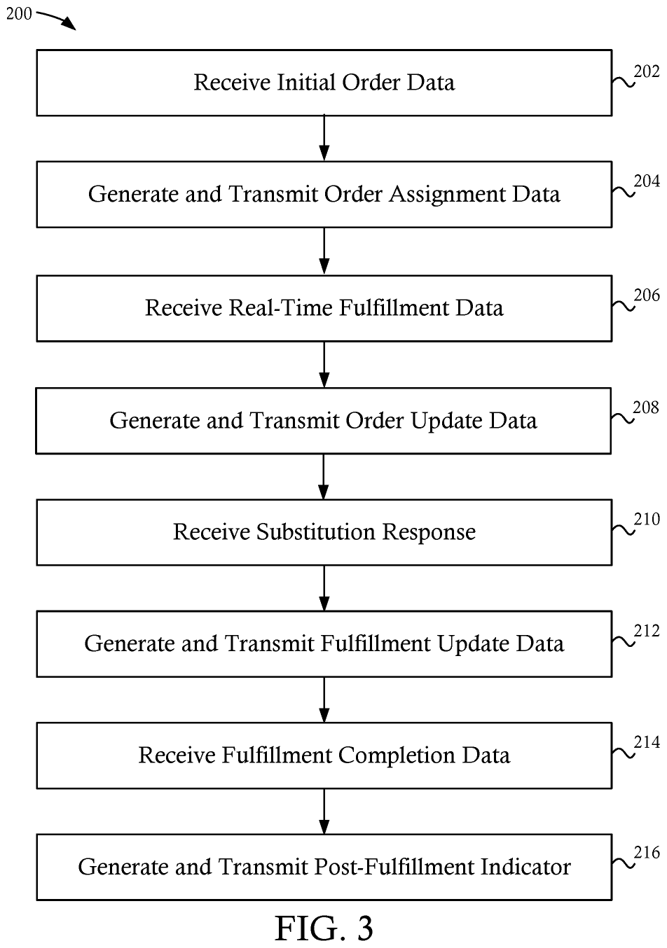

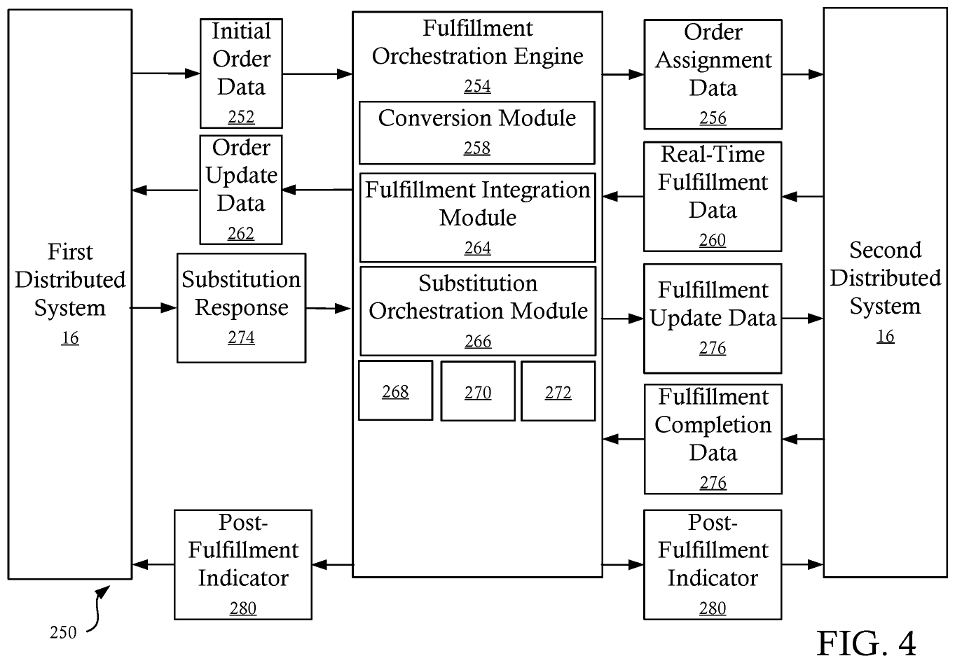

FIG. 3 is a flowchart illustrating a distributed fulfillment method 200, in accordance with some embodiments. FIG. 4 is a process flow 250 illustrating various steps of the distributed fulfillment method 200, in accordance with some embodiments. At step 202, initial order data 252 is received. The initial order data 252 identifies one or more items from a catalog associated with a network platform that are to be fulfilled as a single unit, e.g., an order. For example, in some embodiments, the initial order data 252 may identify one or more items in an e-commerce catalog associated with an e-commerce platform that are to be fulfilled as a single e-commerce order. The initial order data 252 may be received from any suitable source, such as, for example, a first distributed computing device 16. The initial order data 252 may be received by any suitable system, device, module, model, engine, etc., such as, for example, a fulfillment orchestration engine 254.

In some embodiments, the initial order data 252 is generated by and/or in conjunction with an order application executed by the first distributed computing device 16. The order application may include an application associated with a specific platform, such as a specific network platform, and/or may be associated with a generic platform. The order application may be configured to receive one or more inputs from a user via the first distributed computing device 16 to identify items for inclusion in an order and/or to execute generation of the initial order data 252. In some embodiments, the order application is configured to receive inputs identifying one or more substitute preferences for use in generating substitute items, as discussed in greater detail below. The inputs identifying one or more substitute preferences may be received during generation of the order and/or as a separate process.

At step 204, order assignment data 256 is generated and transmitted to a distributed computing device selected and/or assigned to facilitate fulfillment of the order, such as, for example, a second distributed computing device 18. The order assignment data 256 includes at least a portion of the initial order data 252, such as, for example, one or more identifiers related to the set of items selected for inclusion in the order. In some embodiments, the order assignment data 256 is configured to modify and/or populate an order fulfillment application to facilitate fulfillment of the corresponding order. The order assignment data 256 may be provided directly to the second distributed computing device 18 and/or may be provided to an assignment server configured to select the second distributed computing device 18 from a pool of distributed computing devices.

In some embodiments, the order assignment data 256 is generated by the fulfillment orchestration engine 254. The fulfillment orchestration engine 254 may convert and/or package a portion of the initial order data 252 into a format suitable for ingestion and processing by a fulfillment application executing on the second distributed computing device 18. The fulfillment orchestration engine 254 may include a platform-specific conversion module 258 configured to convert the selected portion of the initial order data 252 into a format suitable for use with the corresponding platform of the fulfillment application. In some embodiments, the fulfillment orchestration engine 254 may include multiple platform-specific conversion modules each configured to convert the selected portion of the initial order data 252 into a format suitable for one of a plurality of corresponding platforms.

In some embodiments, the order assignment data 256 includes data identifying the one or more items included in the initial order data 252 and at least one preferred substitute for at least one of the items of the order. For example, during an order generation process (e.g., prior to and/or in conjunction with generation of the initial order data 252), the order application may receive a selection of a preferred substitute for one or more items. Data identifying a selected preferred substitute may be included in the initial order data 252. As another example, in some embodiments, substitution preferences may be obtained prior to generation of an order, for example, through the order application and/or through a separate application or interface. A substitution preference may be stored in a database and associated with a specific device, e.g., a first distributed computing device 16, a specific user, etc. When an order is received that is associated with the same device, user, etc., the fulfillment orchestration engine 254 may obtain substitution preferences for one or more items in the initial order data 252 from the database. Data identifying the one or more selected substitution preferences may be included in the order assignment data 256 and/or otherwise provided to the second distributed computing device 18.

At step 206, real-time fulfillment data 260 is received. In some embodiments, the real-time fulfillment data 260 indicates fulfillment status of one or more items in an order. The real-time fulfillment data 260 may be provided by any suitable system and/or application, such as, for example, the fulfillment application executed by the second distributed computing device 18. In some embodiments, the real-time fulfillment data 260 corresponds to pick data obtained and/or generated by the fulfillment application during fulfillment of the order. For example, when an item in an order is fulfilled (e.g., picked, obtained, packaged, etc.), the fulfillment application may generate real-time fulfillment data 260 indicating fulfillment of the corresponding item. In some embodiments, real-time fulfillment data 260 may be generated in response to receiving one or more inputs, such as, for example, a user input indicating fulfillment of an item, a scan of an identifier (e.g., barcode, UPC, etc.) associated with a fulfilled item, etc.

In some embodiments, the real-time fulfillment data 260 includes a substitution notification. For example, in some embodiments, during fulfillment of an order, a first item may be unavailable (e.g., out-of-stock, insufficient stock, etc.). When a first item is unavailable, a substitute item may be identified for inclusion in the order in place of the first item. The substitute item may be selected by an automated process (e.g., a trained machine-learning substitution model, a rules-based substitution model, etc.) and/or may be selected manually (e.g., by an individual associated with the second distributed computing device 18 and actively fulfilling the order). In some embodiments, a substitution notification indicates the first item and a selected substitute item. The substitution notification may be generated in response to an input indicating that a first item is unavailable, selection of a proposed substitute item, selection of manually-identified substitute item, etc.

In some embodiments, the real-time fulfillment data 260 includes an unavailable item notification. For example, in some embodiments, during fulfillment of an order, a second item may be unavailable (e.g., out-of-stock, insufficient stock, etc.). When a second item is unavailable, an unavailable notification may be generated indicating the second item is unavailable. In some embodiments, and as discussed in greater detail below, a proposed substitution may be received in response to an unavailable item notification.

In some embodiments, real-time fulfillment data 260 is generated each time a status of an item is modified by the fulfillment application. For example, real-time fulfillment data 260 may be generated each time data identifying fulfillment, substitution, and/or availability of an item is generated and/or received by the fulfillment application. The real-time fulfillment data 260 may be generated by scanning an identifier associated with an item and/or a substitute item, through one or more user inputs, and/or using any other suitable generation process. In some embodiments, real-time fulfillment data 260 is generated at a near real-time interval, such as, for example, every 10 seconds, every 20 seconds, every 30 seconds, etc., and includes each item status change that occurred since a prior set of real-time fulfillment data 260 was generated.

At step 208, order update data 262 is generated and provided to the order application. For example, in some embodiments, the fulfillment orchestration engine 254 is configured to generate order update data 262 in response to receiving real-time fulfillment data 260. Order update data 262 may include a status change or update for one or more items in the order, a substitution confirmation request for one or more substitutions, and/or an unavailable notification for an unavailable item. In some embodiments, the fulfillment orchestration engine 254 is configured to receive the real-time fulfillment data 260 and integrate additional item data for update included in the order update data 262.

In some embodiments, order update data 262 is generated in real-time and/or near real-time. For example, order update data 262 may be generated in response to receiving each instance of real-time fulfillment data 260 such that the order update data 262 is generated in real-time with respect to fulfillment updates received from the second distributed computing device 18. As another example, order update data 262 may be generated at a predetermined near real-time interval, such as, for example, every 10 seconds, every 20 seconds, every 30 seconds, etc. In some embodiments, a near real-time interval may be used to reduce processing resources while providing an acceptable time frame for identification, acceptance, rejection, and/or other interactions with substitute and/or unavailable items, as discussed below. In some updates, if no real-time fulfillment data 260 was received in a predetermined time period since generation of prior order update data 262, e.g., the near real-time interval elapses without receiving real-time fulfillment data 260, step 208 may be skipped and no order update data 262 is generated.

In some embodiments, real-time fulfillment data 260 may include a substitution indication identifying a substitute item substituted for a first item in an order. The real-time fulfillment data 260 may be received by a fulfillment integration module 264 configured to receive the real-time fulfillment data 260 and extract corresponding substitution data for further processing. In some embodiments, the fulfillment integration module 264 is configured to transform the extracted substitution data into a second data format suitable for further processing. The fulfillment integration module 264 provides the extracted and/or transformed data to a substitution orchestration module 266 configured to facilitate notification, approval/rejection, and/or selection related to substitution of one or more items.

In some embodiments, the substitution orchestration module 266 receives the substitution data from the fulfillment integration module 264 and obtains data suitable for generating order update data 262 including a substitution confirmation request. For example, the substitution orchestration module 266 may obtain current order data related to the corresponding order, item data corresponding to the first item and/or the substitute item, real-time parameter data related to the substitute item, and/or any other suitable data. The data suitable for generating a substitution confirmation request may be obtained from one or more suitable modules and/or data repositories.

For example, in some embodiments, current order data may be obtained form an order services module 268. The order services module 268 is configured to store and/or maintain data related to one or more currently pending orders, such as the order associated with the initial order data 252. The order services module 268 may provide identification of a first distributed computing device 16 associated with the corresponding order, user data associated with a user associated with the order, the initial order data 252, and/or any other suitable order data.

As another example, in some embodiments, item data may be provided by and/or obtained from an item services module 270. The item services module 270 is configured to obtain item catalog data for one or more items, such as a first item or a substitute item. The obtained item data may include, but is not limited to, item titles, descriptions, images, parameters, etc. The item services module 270 may be configured to obtain static and/or dynamic catalog information related to one or mode selected items. In some embodiments, the item services module 270 is configured to provide a predetermined portion of item catalog data, such as, for example, a title and an image of an identified substitute item.

As still another example, in some embodiments, real-time parameter data may be provided by and/or obtained from a real-time data service module 272. The real-time data service module 272 is configured to obtain real-time data for one or more items, such as a substitute item. The real-time data may include, but is not limited to, item pricing, inventory, etc. In some embodiments, the item services module 270 is configured to obtain static data and the real-time data service module 272 is configured to obtain dynamic data, although it will be appreciated that item service module 270 and/or the real-time data service module 272 may each be configured to obtain any suitable data from any suitable data sources.

In some embodiments, a substitution confirmation request is configured to incorporate data related to a first item selected for inclusion in an order and a substitute item selected as a substitute for the first item. For example, in some embodiments, the order services module 268 may be configured to obtain a portion of initial order data 252 identifying the first item selected for inclusion in the order. Item data, such as an image and a title, for the first item and a substitute item identified in received real-time fulfillment data 260 may be obtained from the item services module 270. In addition, real-time data, such as real-time pricing data, may be obtained from the real-time data service module 272. The obtained image data, title data, and pricing data may be packaged by the substitution orchestration module 266 in a substitution confirmation request incorporated into order update data 262. The substitution confirmation request is configured to cause the first distributed computing device 18 to generate an interface including a substitution confirmation interface element.

At step 210, a substitution response 274 is received. The substitution response 274 may be configured identify an approval or rejection of a substitute item identified for a first item of the order. For example, in some embodiments, in response to receiving a substitution confirmation request and generating a substitution confirmation interface element, a first distributed computing device 16 may receive an approval input indicative of an acceptance or rejection of the selected substitute item. The approval input may be included in a substitution response 274 received by the fulfillment orchestration engine 254. In some embodiments, the approval input may include a rejection of the substitute item and identification of a preferred substitute item.

In some embodiments, the substitution response 274 includes a preferred and/or proposed substitution for an unavailable item. For example, in some embodiments, real-time fulfillment data 260 may indicate that a requested first item is not available for fulfillment. Order update data 262 including an unavailable indication may be generated and transmitted to the first distributed computing device 16. In response to the order update data 262 and input data identifying a preferred substitute, a substitution response 274 may be generated and provided to the fulfillment orchestration engine 254.

At step 212, fulfillment update data 276 is generated to update the fulfillment application in response to the received substitution response 274. For example, if the substitution response 274 indicates acceptance of a selected substitute item, the fulfillment application may be updated to indicate that acceptance. For example, in some embodiments, the status of the first item selected for the order may be changed to fulfilled based on the acceptance of the substitute item. Alternatively, if the substitution response 274 indicates rejection of a selected substitute item, the fulfillment application may be updated to indicate the rejection of the substitute item and/or indicate additional actions to be taken. Additional actions indicated may include, but are not limited to, identification of a preferred substitute item, identification of a second proposed substitute item, a don't fulfill indication indicating that no substitutes should be made for the first item, etc.

In some embodiments, the fulfillment update data 276 includes identification of a substitute item different than the selected substitute item. For example, as discussed above, a substitution response 274 may include identification of a preferred substitute item. The fulfillment update data 276 may cause and/or be used by the second distributed computing device 16 to generate a substitution fulfillment interface indicating the first substitute item was rejected and that a preferred substitute item was identified. As another example, in some embodiments, a substitution response 274 may indicate rejection of a first substitute item and a proposed second substitute item may be selected for inclusion in the order. The proposed second substitute item may be generated by any suitable system, device, module, engine, model, etc., such as, for example, a substitute item recommendation model.

In some embodiments, the distributed fulfillment method 200 may repeat and/or return to any of steps 206-212. For example, in some embodiments, additional real-time fulfillment data 260 may be received based on fulfillment status updates for one or more additional items in an order. As another example, in some embodiments, an additional substitution response 274 may be received in response to order update data 262 indicating a substitution for a second item in an order. It will be appreciated that each of steps 206-212 may be repeated any number of times prior to completion of the distributed fulfillment method 200.

At step 214, fulfillment completion data 278 is received. The fulfillment completion data 278 indicates completion of a fulfillment process for the corresponding order. For example, in some embodiments, fulfillment completion data 278 may indicate that all items in an order have been fulfilled, substituted, and/or are unavailable. As another example, in some embodiments, fulfillment completion data 278 indicates that modifications to an order are no longer possible, for example, because a fulfillment step has been completed that prevents further modifications (e.g., payment has been processed for the selected items and substitutes in the order). The fulfillment completion data 278 may be generated by the second distributed computing device 18 in response to one or more inputs, such as, for example, an order complete input, input of fulfillment data for the final item in an order, etc.

At step 216, a post-fulfillment indicator 280 is generated. The post-fulfillment indicator 280 is configured to transition one or more applications, such as the order application and/or the fulfillment application, to a post-fulfillment state. The post-fulfillment state may allow communication between the order application and the fulfillment application via one or more communication channels, such as a text channel. In some embodiments, the post-fulfillment state includes one or more interface elements for generating feedback data, such as feedback data related to the acceptability of presented substitutions, substitution preferences, order preferences, etc. The feedback data may be provided to one or more additional processes, such as, for example, a machine learning training process as discussed in greater detail below.

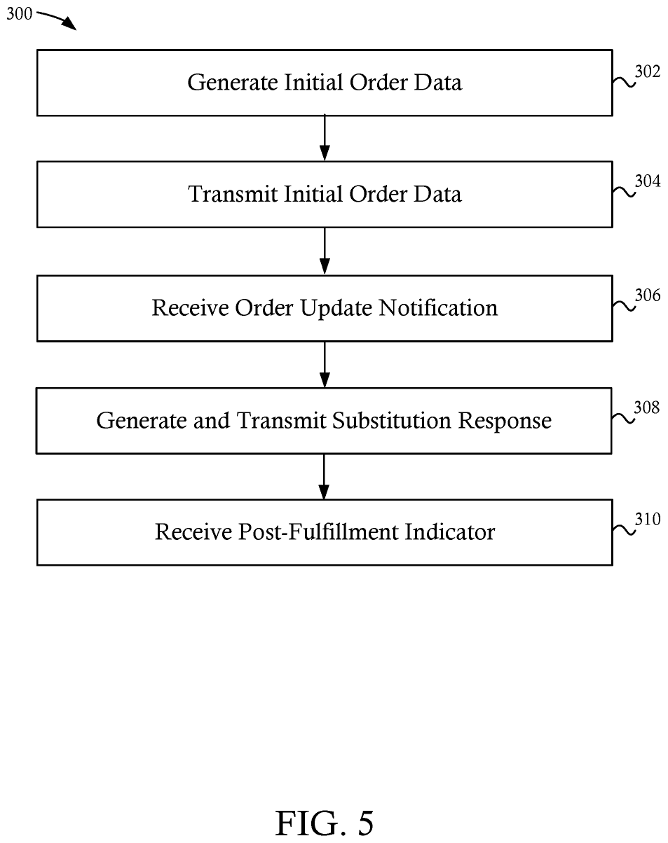

FIG. 5 is a flowchart illustrating an order application workflow 300, in accordance with some embodiments. The order application workflow 300 is configured to be executed by a distributed computing device in communication with the fulfillment orchestration engine 254, such as, for example, a first distributed computing device 16. At step 302, initial order data 252 is generated. The initial order data 252 may be generated by an order application executed by a first distributed computing device 16. For example, in some embodiments, an order application is configured to receive one or more inputs to find (e.g., search for) and select one or more items from an associated item catalog for inclusion in an order. The initial order data 252 may be generated responsive to the one or more inputs.

At step 304, the initial order data 252 is transmitted to a fulfillment orchestration computing device 4. As discussed above with respect to FIGS. 3-4, the fulfillment orchestration computing device 4 may be configured to implement a distributed fulfillment method 200 to facilitate fulfillment of an order embodied in the received initial order data 252.

At step 306, order update data 262 is received and an order status interface is generated. As discussed with respect to FIGS. 3-4, the order update data 262 includes data identifying one or more updates to an order status, such as, for example, fulfillment status for one or more items in the order, substitution selections for one or more items in the order, etc. The order status interface may be generated responsive to receiving the order update data 262 and/or may be generated in response to one or more user inputs. For example, in some embodiments, order update data 262 may be transmitted via a first communication channel and may include data, such as link data, configured to cause generation of the order status interface in response to a input selecting the link data. Although specific embodiments are discussed herein, it will be appreciated that the order status interface may be generated in response to any suitable received data and/or input.

The order status interface includes one or more elements configured to provide order status information for a corresponding order. The order status information may include, but is not limited to, general order updates, fulfillment status for one or more items, substitution notifications for one or more items, unavailable notifications for one or more items, etc. The order status interface may include one or more interface elements configured to present order status information and receive one or more inputs responsive to the order status information. For example, in some embodiments, an order status interface may include one or more substitution interface elements generated in response to a substitution confirmation request included in order update data 262. As another example, in some embodiments, an order status interface may include one or more unavailable item interface elements generated in response to an unavailable item notification included in order update data 262. It will be appreciated that the order status interfaces discussed herein may be modified to include additional and/or alternative interface elements in some embodiments.

At optional step 308, a substitution response 274 is generated and transmitted to the fulfillment orchestration computing device 4. The substitution response 274 may be generated in response to one or more inputs indicating approval or rejection of a selected substitute item and/or may be generated in response to one or more inputs indicating a preferred substitute item for an unavailable item. A substitution response 274 may be generated for each substitution approval/rejection and/or preferred substitution selection and/or may be generated for a set of substitution approval/rejections and/or preferred substitution selections performed within a predetermined time period, such as, for example, 10 seconds, 20 seconds, 30 seconds, etc.

At step 310, a post-fulfillment indicator 280 is received and the order application is transitioned to a post-fulfillment state. The post-fulfillment state is configured to provide updates related to one or more additional order steps, such as, for example, a delivery step. In some embodiments, the post-fulfillment state enables communication between the first distributed computing device 16 and the second distributed computing device 18 to facilitate delivery of an order to a user and/or address associated with the first distributed computing device 16.

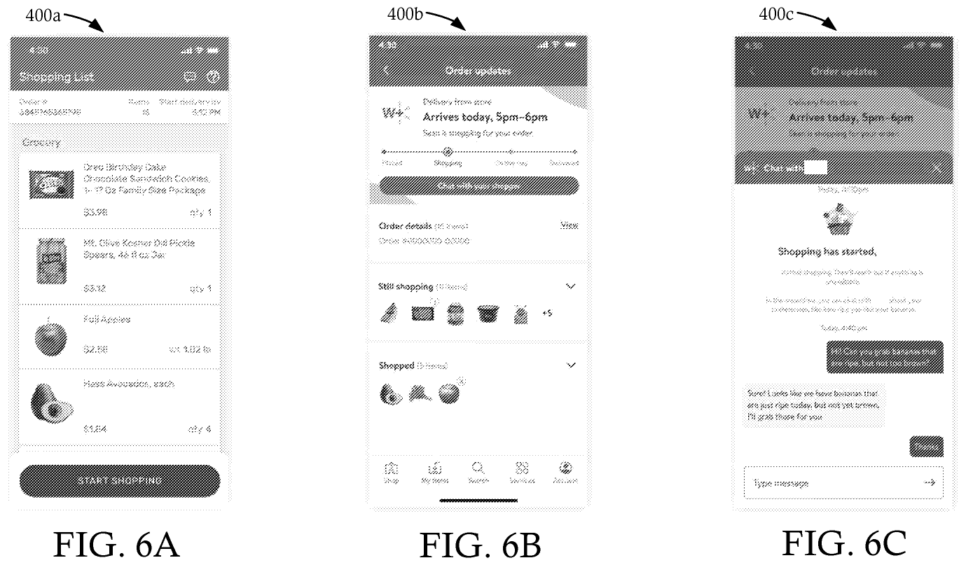

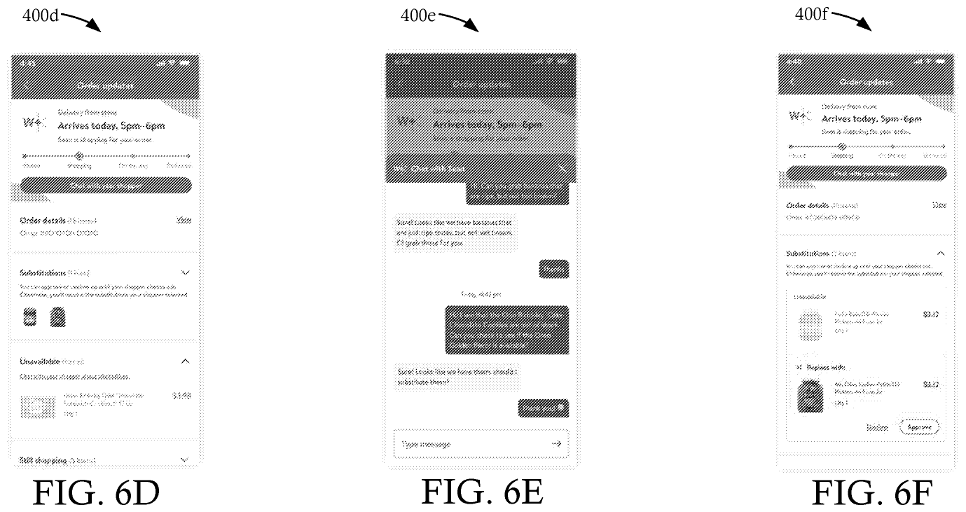

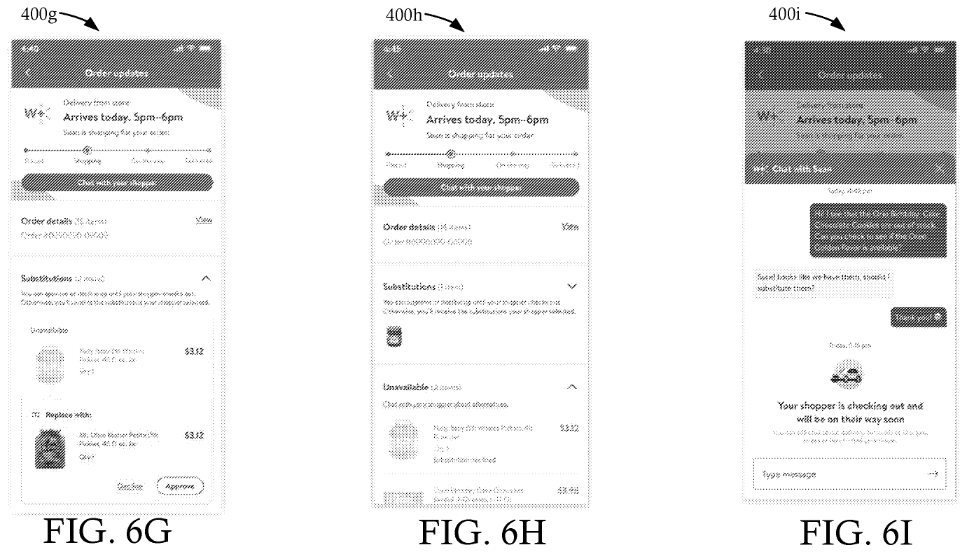

FIGS. 6A-6I illustrates a series of order application interfaces 400a-400i generated during one or more steps of the distributed fulfillment process 200 and/or the order application workflow 300, in accordance with some embodiments. The order application interfaces 400a-400i each include a header, an order status interface element, one or more additional interface elements such as one or more substitution interface elements, status interface elements, etc., and/or any other suitable interface elements. In some embodiments, an order status interface element is configured to provide general order updates, a first item status interface element is configured to identify items in an order that are not yet fulfilled, and a second item status interface element is configured to identify items in an order that have been previously fulfilled. In some embodiments, the order application interfaces 400a-400i and/or a portion thereof is generated in response to and/or based on a received substitution confirmation request.

In some embodiments, one or more order application interfaces 400a-400i include one or more substitution confirmation interface elements each corresponding to an item substitution identified by a substitution conformation request. The substitution confirmation interface elements may be configured to receive one or more inputs indicative of an acceptance, a rejection, and/or a new substitution for a previously substituted and/or unavailable item. The substitution confirmation interface elements may include one or more interactive interface elements configured to receive an input indicative of an acceptance, a rejection, and/or a new substitution.

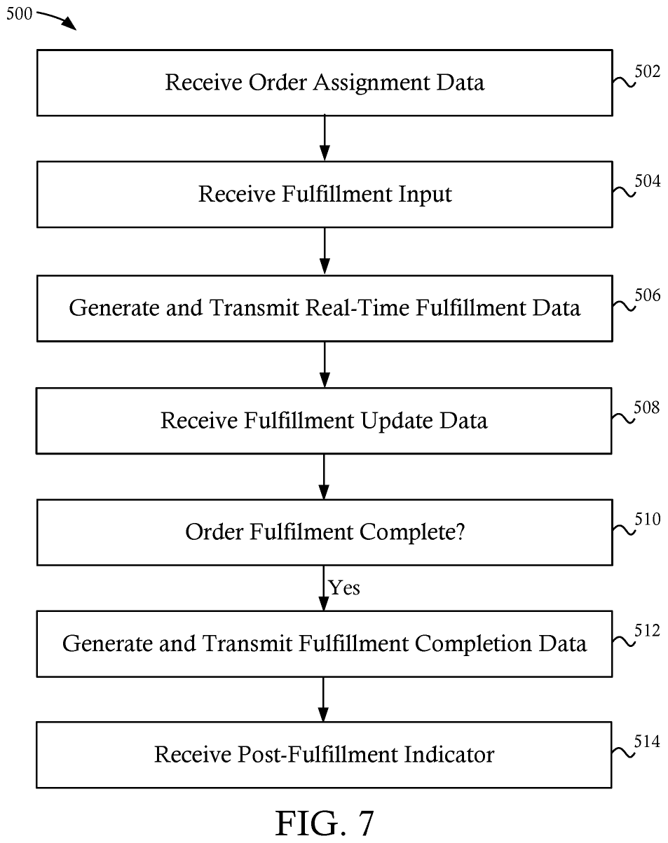

FIG. 7 is a flowchart illustrating a fulfillment application workflow 500, in accordance with some embodiments. The fulfillment application workflow 500 is configured to be executed by a distributed computing device in communication with the fulfillment orchestration engine 254, such as, for example, a second distributed computing device 18. At step 502, order assignment data 256 is received. The order assignment data 256 may be received by a fulfillment application executed by a second distributed computing device 18. For example, in some embodiments, a fulfillment orchestration engine 254 is configured to generate order assignment data 256 and transmit the generated order assignment data 256 to the second distributed computing device 18.

At step 504, a fulfillment input is received. The fulfillment input may be indicative a fulfillment status of one or more items in an order. For example, in some embodiments, the fulfillment input may indicate that a first item of an order has been fulfilled (e.g., the first item has been picked, obtained, packaged, etc.), that a first item of an order is unavailable, that a first item of an order is unavailable and a specific substitute item has been selected, etc. The fulfillment input may be generated by the second distributed computing device 18, for example, in conjunction with fulfillment of an order by a user of the second distributed computing device 18.

At step 506, real-time fulfillment data 260 is generated and transmitted, for example, to a fulfillment orchestration engine 254. The real-time fulfillment data 260 indicates fulfillment status of one or more items in an order. For example, in some embodiments, real-time fulfillment data 260 may indicate that an item has been fulfilled, that an item is unavailable, that a substitute has been selected for an item, etc. The real-time fulfillment data 260 may be generated in response to receiving a fulfillment input and/or at a predetermined interval such as 10 seconds, 20 seconds, 30 seconds, etc.

At step 508, fulfillment update data 276 is received. The fulfillment update data 276 may be configured to modify the fulfillment application implemented by the second distributed computing device 18 to indicate acceptance or rejection of a selected substitute item, present one or more proposed substitute items, and/or indicate that an unavailable item should not be substituted. For example, in some embodiments, fulfillment update data 276 may include one or more proposed substitutions for an unavailable item, such as one or more machine learning generated proposed substitutions, one or more selected preferred substitutions, one or more prior accepted substitutions, etc.

At step 510, the fulfillment application determines whether fulfillment of the order is complete. For example, when all of the items in an order have been fulfilled, substituted, and/or identified as unavailable, fulfillment of the order may be complete. As another example, fulfillment of an order may be considered complete when a subsequent action, such as a checkout, packaging, shipping, etc. action is implemented. In some embodiments, the determination is based on one or more inputs received by the second distributed computing device 18. For example, in some embodiments, one or more user inputs indicative of fulfillment completion are received.

At step 512, fulfillment completion data 278 is generated and provided to the fulfillment orchestration engine 254. In some embodiments, fulfillment completion data 278 includes data indicating that all items in an order have been fulfilled, substituted, and/or are unavailable. The fulfillment completion data 278 may be generated in response to one or more received inputs. For example, in some embodiments, fulfillment completion data 278 may be generated in response to a fulfillment completion input. In some embodiments, a predetermined delay may be introduced between receipt of the fulfillment completion input and generation of the fulfillment completion data 278. For example, in some embodiments, a predetermined delay equal to the real-time fulfillment data 260 generation rate is provided between receipt of the fulfillment completion input and generation of the fulfillment completion data 278, for example, to allow for generation and transmission of fulfillment update data 276 in response to one or more substitute items added to the order. It will be appreciated that any suitable delay may be introduced for any purpose between receipt of an input indicating completion of fulfillment for an order and transmission of fulfillment completion data 278.

At step 514, a post-fulfillment indicator 280 is received and the fulfillment application is transitioned to a post-fulfillment state. The post-fulfillment state is configured to generate updates related to one or more additional order steps, such as, for example, a delivery step. In some embodiments, the post-fulfillment state enables communication between the first distributed computing device 16 and the second distributed computing device 18 to facilitate delivery of an order to a user and/or address associated with the first distributed computing device 16. In some embodiments, the post-fulfillment state includes transmission of location data, such as global positioning satellite (GPS) location data, of the second distributed computing device 18.

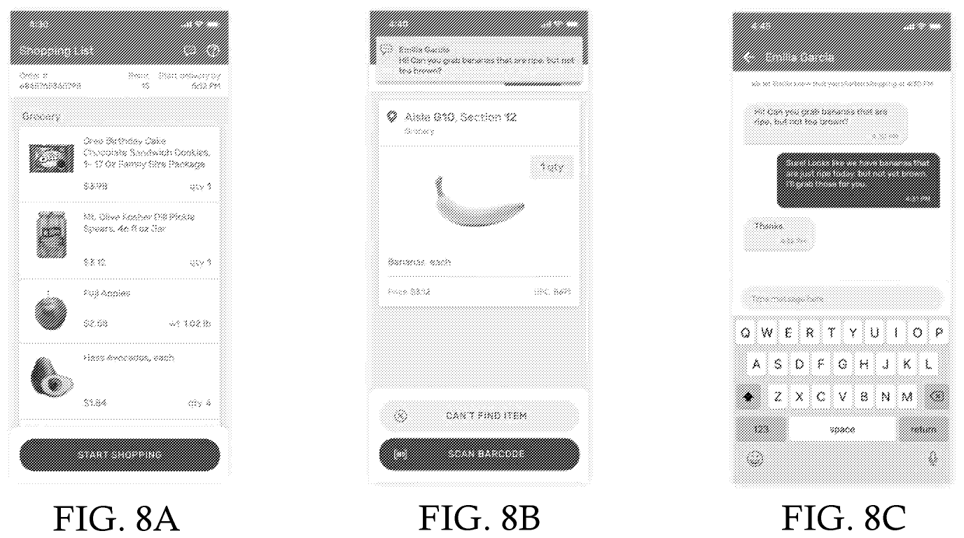

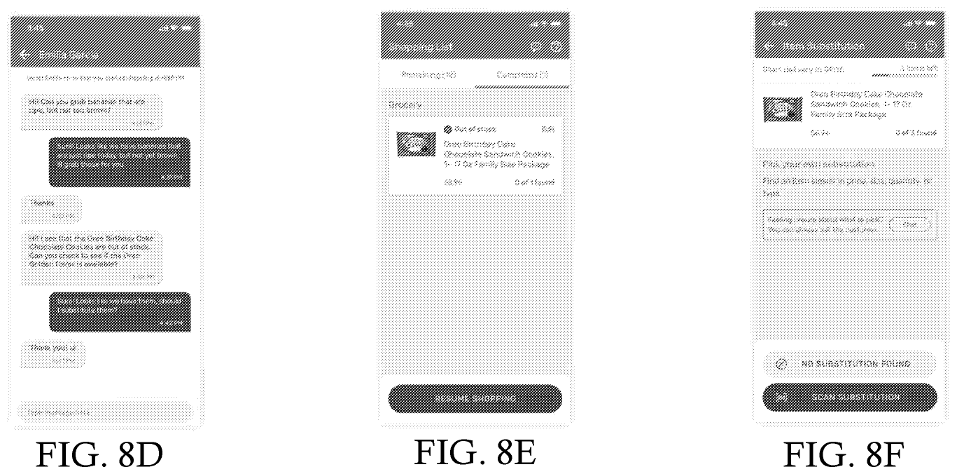

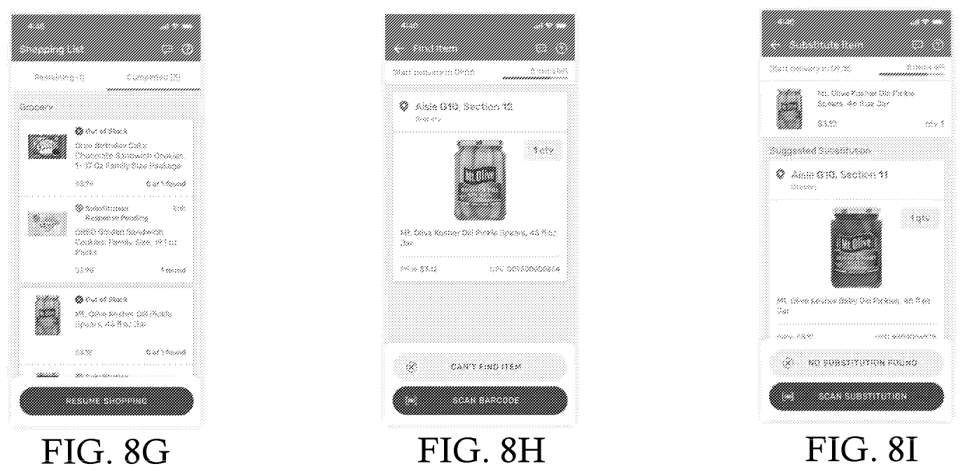

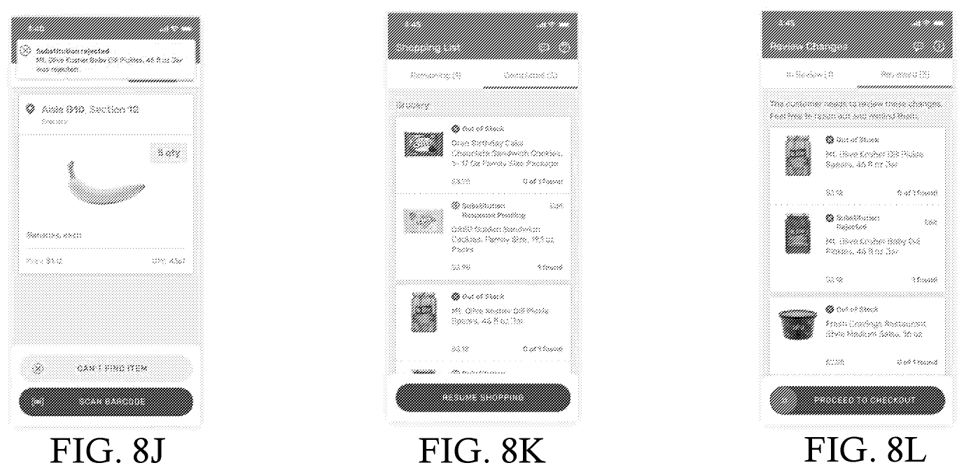

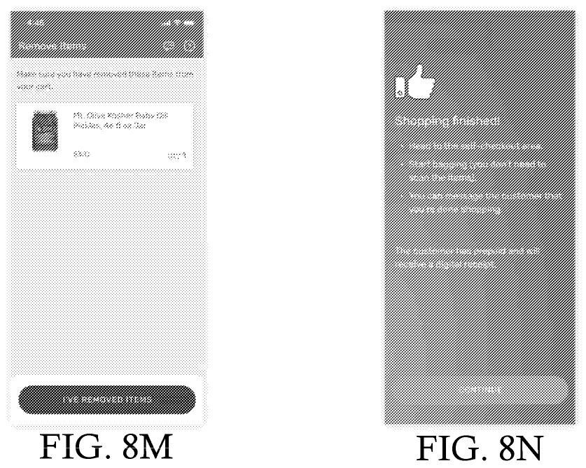

FIGS. 8A-8N illustrates a series of fulfillment application interfaces 600a-600n generated during one or more steps of the distributed fulfillment process 200 and/or the fulfillment application workflow 500, in accordance with some embodiments. The fulfillment application interfaces 600a-600n each include a header and one or more additional interface elements such as one or more substitution interface elements, status interface elements, etc., and/or any other suitable interface elements. In some embodiments, the order application interfaces 400a-400i and/or a portion thereof is generated in response to and/or based on fulfillment update data 276.

In some embodiments, one or more fulfillment application interfaces 600a-600n include one or more substitution selection elements each corresponding to an item substitution confirmed by fulfillment update data 276. The substitution selection elements may be configured to receive one or more inputs indicative of fulfillment of a selected substitute item. The substitution selection elements may include one or more interactive interface elements configured to receive an input indicative of fulfillment of a selected substitute item.

Identification and approval or rejection of substitutions for items during a distributed fulfillment method can be burdensome and time consuming for users, or in some instances impossible, especially if such substitutions are not presented until after completion of an order fulfillment stage. Typically, a user may receive post-fulfillment information indicating substituted items. Such post-fulfillment information does not provide for and/or allow modifications to substitutions in real-time, instead providing a delayed or no opportunity to identify alternative substitutions. Thus, a user frequently has to perform numerous additional steps to accept or reject substituted items.

Distributed fulfillment systems, as disclosed herein, significantly reduce this problem, allowing users to review, approve, rejection, and/or identify substitute items in real-time or near real-time with fewer, or in some case no, active steps. For example, in some embodiments described herein, when a substitute item is selected, a user is presented with a substitute item interface element that includes, or is in the form of, a link to an interface page for approval, rejection, or recommendation of an alternative substitute element. Each substitution notification thus serves as a programmatically selected navigational shortcut to an interface page, allowing a user to bypass the navigational structure of the an ordering application. Beneficially, identifying item substitutions and presenting a user with navigational shortcuts to approve, rejection, or recommend an alternative substitute improves the speed of a fulfillment process.

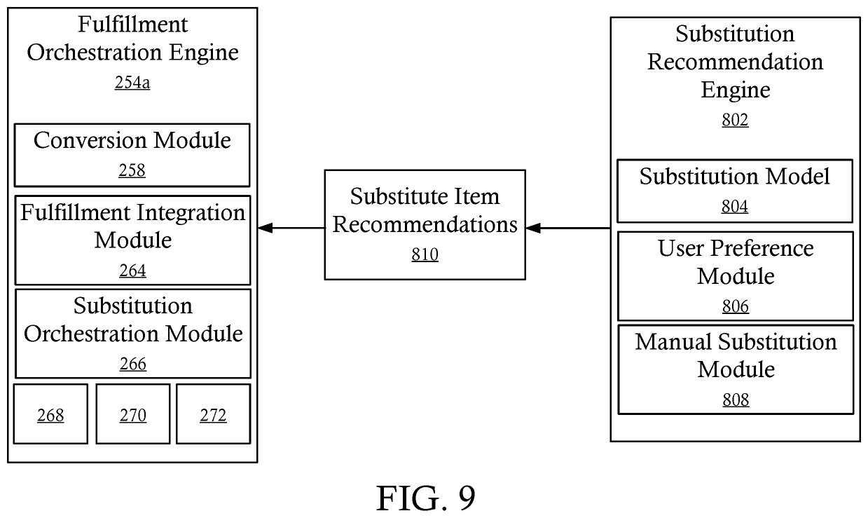

FIG. 9 illustrates a substitution and order fulfillment architecture 800, in accordance with some embodiments. The substitution and order fulfillment architecture 800 includes a fulfillment orchestration engine 254a and a substitution recommendation engine 802. The fulfillment orchestration engine 254a is similar to the fulfillment orchestration engine 254 discussed above, and similar description is not repeated herein. In some embodiments, a substitution recommendation engine 802 is configured to generate one or more substitute item recommendations.

For example, in some embodiments, the substitution recommendation engine 802 includes a substitution recommendation model 804. The substitution recommendation model 804 may include a trained machine learning model configured to generate one or more substitute item recommendations. The substitution recommendation model 804 may be configured to receive one or more inputs, such as an unavailable item (e.g., an anchor item) and generate one or more recommended substitutions based on item similarity, substitute acceptability, and/or any other suitable parameters and/or features. In some embodiments, the substitution recommendation model 804 is configured to generate a first set of recommended substitute items.

In some embodiments, the substitution recommendation engine 802 includes a user preference module 806 configured to generate substitute item recommendations based one or more identified user preferences. For example, in some embodiments (and as discussed above), a preferred substitute item may be selected by a user prior to and/or during creation of an order. The user preference module 806 may be configured to obtain a preferred substitute item from a set of substitute items associated with a user associated with a device, such as the first distributed computing device 16.

In some embodiments, the substitution recommendation engine 802 is configured to allow for one or more manual substitutions, for example, a substitution selected during a fulfillment process. In some embodiments, a manual substitution for a first item may be identified based on input from a distributed computing system, such as the second distributed computing system 18. When the same item is subsequently identified, the manual substitution module 808 may select a substitution based on prior manual substitutions of the first item.

In some embodiments, the substitution recommendation engine 802 is configured to provide a set of recommended substitute items 810 to the fulfillment orchestration engine 254a. The fulfillment orchestration engine 254a may be configured to provide the set of recommended substitute items 810 as part of a distributed fulfillment method 200. For example, in some embodiments, the fulfillment orchestration engine 254a may incorporate the recommended substitute items 810 into order assignment data 256 to facilitate selection of substitute items during order fulfillment. As another example, in some embodiments, the fulfillment orchestration engine 254a may include one or more the recommended substitute items 810 in an unavailable item notification to facilitate selection of a substitute item by a user. It will be appreciated that the recommended substitute items 810 may be included in any suitable step of the distributed fulfillment method 200 discussed above.

It will be appreciated that real-time selection and approval/rejection of one or more substitute items, as disclosed herein, particularly for large catalogs associated with e-commerce platforms, is only possible with the aid of computer-assisted algorithms and techniques, such as the disclosed distributed fulfillment systems, a trained substitution identification model, etc. In some embodiments, machine learning processes including a trained substitution identification model are used to perform operations that cannot practically be performed by a human, either mentally or with assistance, such as identifying acceptable item substitutions within a diverse e-commerce catalog in real-time or near real-time. It will be appreciated that a variety of machine learning techniques can be used alone or in combination to generate trained substitution identification models.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

In some embodiments, a trained function may include a neural network, a support vector machine, a decision tree, a Bayesian network, a clustering network, Qlearning, genetic algorithms and/or association rules, and/or any other suitable artificial intelligence architecture. In some embodiments, a neural network may be a deep neural network, a convolutional neural network, a convolutional deep neural network, etc. Furthermore, a neural network may be an adversarial network, a deep adversarial network, a generative adversarial network, etc.

In various embodiments, neural networks which are trained (e.g., configured or adapted) to generate substitute item recommendations, are disclosed. A neural network trained to generate substitute item recommendations may be referred to as a trained substitution identification model. A trained substitution identification model may be configured to receive a set of input data, such as a first unavailable item, and generate a set of recommended substitutes that may be provided to a first distributed computing device 16 for approval/rejection of recommended substitutes and/or to a second distributed computing device 18 for facilitating substitution fulfillment of the first item.

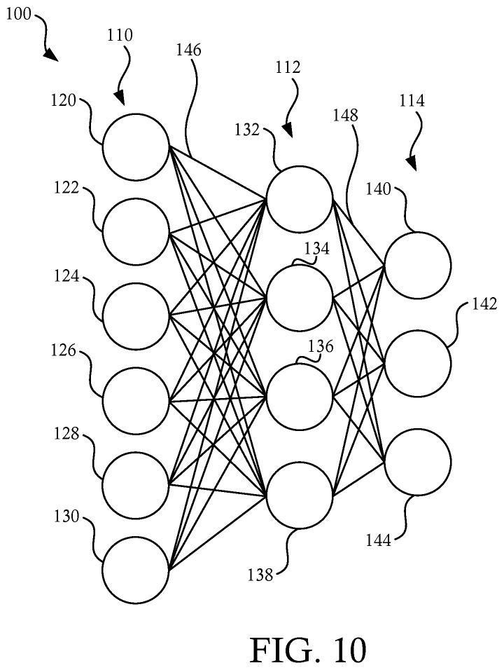

FIG. 10 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δₙ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and γⱼ⁽ⁿ⁺¹⁾ is the comparison training value for the j-th node of the output layer 114.

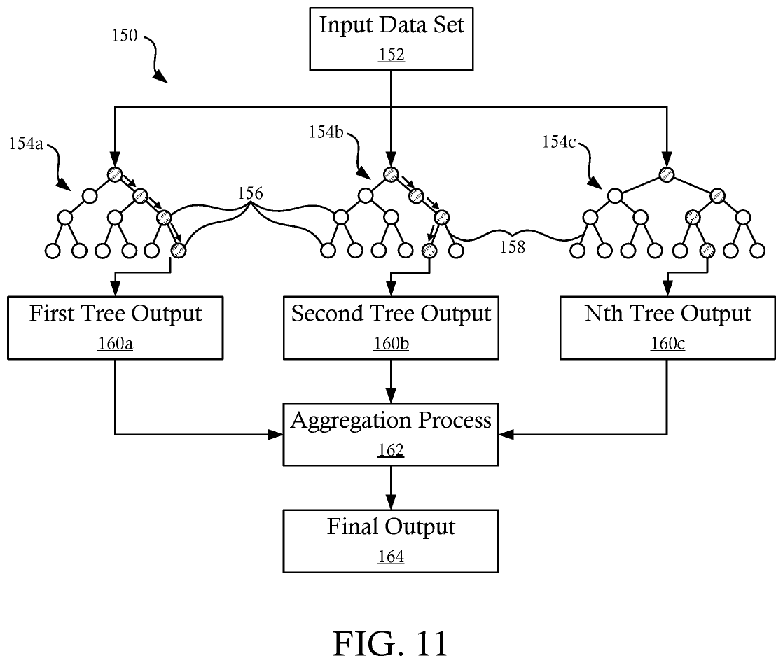

FIG. 11 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c may include a classification and/or a regression tree (CART). Classification trees include a tree model in which a target variable may take a discrete set of values, e.g., may be classified as one of a set of values. In classification trees, each leaf 156 represents class labels and each of the branches 158 represents conjunctions of features that connect the class labels. Regression trees include a tree model in which the target variable may take continuous values (e.g., a real number value).

In operation, an input data set 152 including one or more features or attributes is received. A subset of the input data set 152 is provided to each of the trained decision trees 154a-154c. The subset may include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 may apply a majority-voting process to identify a classification selected by the majority of the trained decision trees 154a-154c. As another example, in embodiments including regression trees, the tree-based neural network 150 may apply an average, mean, and/or other mathematical process to generate a composite output of the trained decision trees. The final output 164 is provided as an output of the tree-based neural network 150.

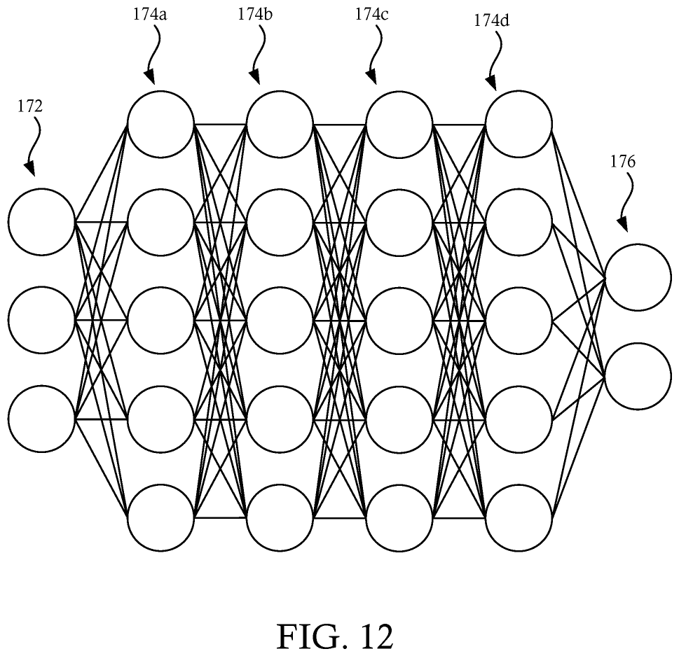

FIG. 12 illustrates a deep neural network (DNN) 170, in accordance with some embodiments. The DNN 170 is an artificial neural network, such as the neural network 100 illustrated in conjunction with FIG. 3, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( ... ( {h}^{( 2 )} ( {a}^{( 2 )} ( {h}^{( 1 )} ( {a}^{( 1 )} ( x ) ) ) ) ) ) ) ) ]$$

where α^{(l)}(x) is a preactivation function and h^{(l)} (x) is a hidden-layer activation function providing the output of each hidden layer. The pre-activation function α^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each ƒᵢ is parametrized by a neural network. In some embodiments, the DNN 170 may include a neural multiplicative model (NMM), including a multiplicative form for the NAM mode using a log transformation of the dependent variable γ and the independent variable x:

$$y = {e}^{β} {e}^{f ( logx )} {e}^{{\sum }_{i} {f}_{i}^{d} ( {d}_{i} )}$$

where d represents one or more features of the independent variable x.

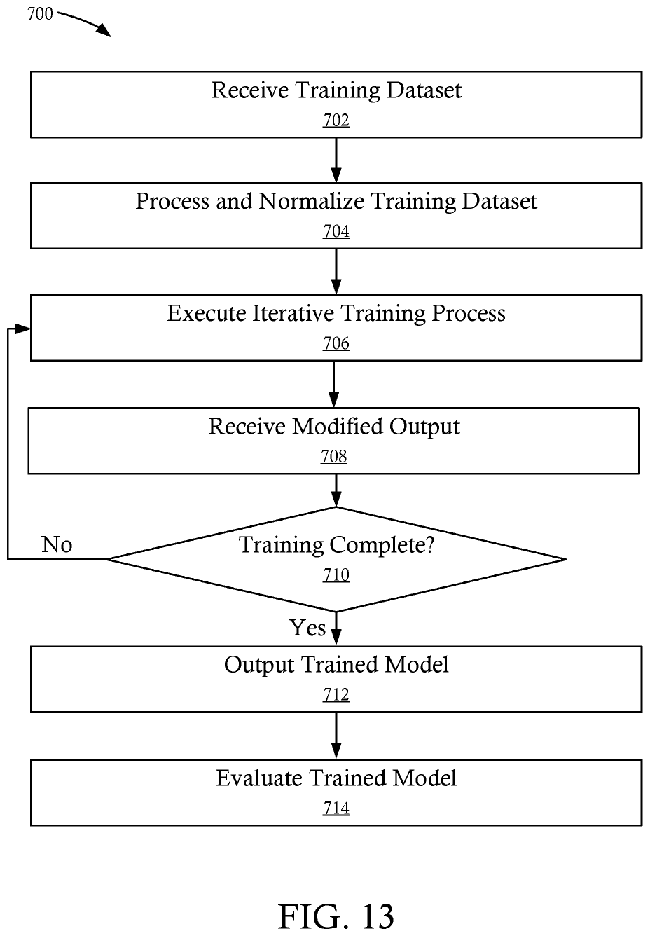

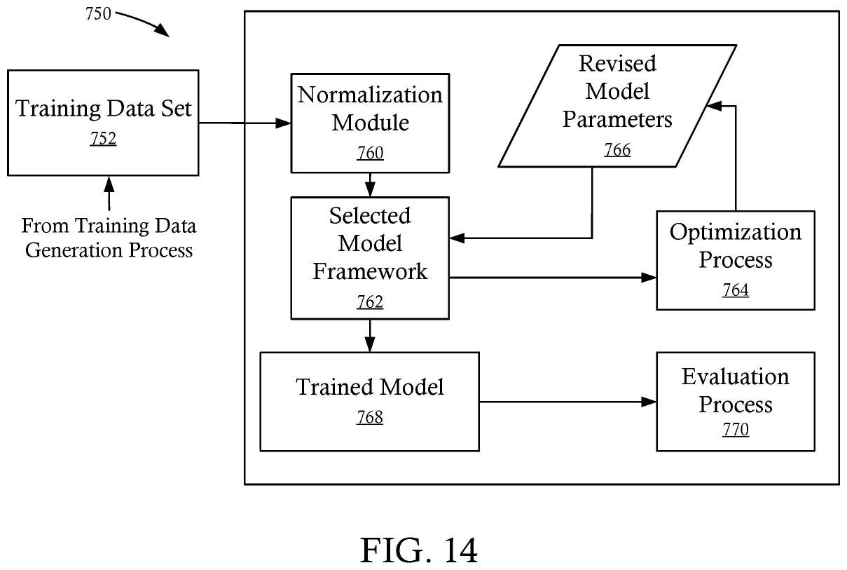

In some embodiments, a fulfillment orchestration engine 254 can include and/or implement one or more trained models, such as a trained substitution selection model. In some embodiments, one or more trained models can be generated using an iterative training process based on a training dataset. FIG. 13 illustrates a method 700 for generating a trained model, such as a trained optimization model, in accordance with some embodiments. FIG. 14 is a process flow 750 illustrating various steps of the method 700 of generating a trained model, in accordance with some embodiments. At step 702, a training dataset 752 is received by a system, such as a processing device 10. The training dataset 752 can include labeled and/or unlabeled data. In some embodiments, the training dataset 752 includes anchor items (e.g., unavailable items) and one or more associated and/or acceptable substitutes.

At optional step 704, the received training dataset 752 is processed and/or normalized by a normalization module 760. For example, in some embodiments, the training dataset 752 can be augmented by imputing or estimating missing values of one or more features associated with a trained substitution selection model. In some embodiments, processing of the received training dataset 752 includes outlier detection configured to remove data likely to skew training of a trained substitution selection model. In some embodiments, processing of the received training dataset 752 includes removing features that have limited value with respect to training of the trained substitution selection model.

At step 706, an iterative training process is executed to train a selected model framework 762. The selected model framework 762 can include an untrained (e.g., base) machine learning model and/or a partially or previously trained model (e.g., a prior version of a trained model). The training process is configured to iteratively adjust parameters (e.g., hyperparameters) of the selected model framework 762 to minimize a cost value (e.g., an output of a cost function) for the selected model framework 762. In some embodiments, the cost value is related to acceptability of a proposed substitute item.

The training process is an iterative process that generates set of revised model parameters 766 during each iteration. The set of revised model parameters 766 can be generated by applying an optimization process 764 to the cost function of the selected model framework 762. The optimization process 764 can be configured to reduce the cost value (e.g., reduce the output of the cost function) at each step by adjusting one or more parameters during each iteration of the training process.

After each iteration of the training process, at step 708, a determination is made whether the training process is complete. The determination at step 708 can be based on any suitable parameters. For example, in some embodiments, a training process can complete after a predetermined number of iterations. As another example, in some embodiments, a training process can complete when it is determined that the cost function of the selected model framework 762 has reached a minimum, such as a local minimum and/or a global minimum.

At step 710, a trained model 768, such as a trained substitution selection model, is output and provided for use in a distributed fulfillment method, such as the distributed fulfillment method 200 discussed above with respect to FIGS. 3-8N. At optional step 712, a trained model 768 can be evaluated by an evaluation process 770. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory;
a processor communicatively coupled to the non-transitory memory, wherein the processor is configured to read a set of instructions to:
receive real-time fulfillment data indicating unavailability of a first item identified in an order from a first computing device, wherein the real-time fulfillment data is generated in response to an input received by the first computing device;
transmit order update data indicating unavailability of the first item and one or more substitute items to a second computing device, wherein the order update data includes at least a portion of the fulfillment data, and wherein the order update data causes the second computing device to generate an interface including the one or more substitute items and the portion of the order update data;
receive a substitute response from the second computing device;
in response to receiving the substitute response:
when the substitute response indicates a selection of one of the one or more substitute items, generate fulfillment update data configured to cause substitution of the selected one of the one or more substitute items in place of the first item during fulfillment; and
when the substitute response indicates a rejection of the one or more substitute items, generate fulfillment update data configured to facilitate removal of the substitute item from the order.

2. The system of claim 1, wherein the order data is received in a first format and, prior to transmitting the order update data, the portion of the fulfillment data included in the order update is formatted to a second format.

3. The system of claim 1, wherein the real-time fulfillment data comprises a proposed substitute item, wherein the one or more substitute items of the order update data include the proposed substitute, and wherein the substitute response indicates the selection or rejection of the proposed substitute.

4. The system of claim 1, wherein at least one of the one or more substitute items is selected based on substitute preference data associated with the second computing device.

5. The system of claim 1, wherein the interface generated in response to the order update data includes at least one interactive element configured to receive an input to define the substitute response, and wherein the substitute response is generated in response to receiving the input.

6. The system of claim 1, wherein the processor is configured to:
receive fulfillment completion data from the first computing device; and
in response to receiving the fulfillment completion data, transmit second order update data to the second computing device, wherein the second order update data is configured to cause the second computing device to transition to a second interface that prevents modification of the order.

7. The system of claim 6, wherein the second interface is configured to facilitate communication between the first computing device and the second computing device.

8. The system of claim 1, wherein at least one of the one or more substitute items is selected by a trained substitution model.

9. A computer-implemented method, comprising:
receiving real-time fulfillment data indicating unavailability of a first item identified in an order from a first computing device, wherein the real-time fulfillment data is generated in response to an input received by the first computing device;
transmitting order update data indicating unavailability of the first item and one or more substitute items to a second computing device, wherein the order update data includes at least a portion of the fulfillment data, and wherein the order update data causes the second computing device to generate an interface including the one or more substitute items and the portion of the order update data;
receiving a substitute response from the second computing device;
in response to receiving the substitute response:
when the substitute response indicates a selection of one of the one or more substitute items, generating fulfillment update data configured to cause substitution of the selected one of the one or more substitute items in place of the first item during fulfillment; and
when the substitute response indicates a rejection of the one or more substitute items, generating fulfillment update data configured to facilitate removal of the substitute item from the order.

10. The computer-implemented method of claim 9, wherein the order data is received in a first format and, prior to transmitting the order update data, the portion of the fulfillment data included in the order update is formatted to a second format.

11. The computer-implemented method of claim 9, wherein the real-time fulfillment data comprises a proposed substitute item, wherein the one or more substitute items of the order update data include the proposed substitute, and wherein the substitute response indicates the selection or rejection of the proposed substitute.

12. The computer-implemented method of claim 9, wherein at least one of the one or more substitute items is selected based on substitute preference data associated with the second computing device.

13. The computer-implemented method of claim 9, wherein the interface generated in response to the order update data includes at least one interactive element configured to receive an input to define the substitute response, and wherein the substitute response is generated in response to receiving the input.

14. The computer-implemented method of claim 9, comprising:
receiving fulfillment completion data from the first computing device; and
in response to receiving the fulfillment completion data, transmitting second order update data to the second computing device, wherein the second order update data is configured to cause the second computing device to transition to a second interface that prevents modification of the order.

15. The computer-implemented method of claim 14, wherein the second interface is configured to facilitate communication between the first computing device and the second computing device.

16. The computer-implemented method of claim 9, wherein at least one of the one or more substitute items is selected by a trained substitution model.

17. A non-transitory computer-readable medium having instructions stored thereon, wherein the instructions, when executed by at least one processor, cause at least one device to perform operations comprising:
receiving real-time fulfillment data indicating unavailability of a first item identified in an order from a first computing device, wherein the real-time fulfillment data is generated in response to an input received by the first computing device;
transmitting order update data indicating unavailability of the first item and one or more substitute items to a second computing device, wherein the order update data includes at least a portion of the fulfillment data, and wherein the order update data causes the second computing device to generate an interface including the one or more substitute items and the portion of the order update data;
receiving a substitute response from the second computing device;
in response to receiving the substitute response:
when the substitute response indicates a selection of one of the one or more substitute items, generating fulfillment update data configured to cause substitution of the selected one of the one or more substitute items in place of the first item during fulfillment; and
when the substitute response indicates a rejection of the one or more substitute items, generating fulfillment update data configured to facilitate removal of the substitute item from the order.

18. The non-transitory computer-readable medium of claim 17, wherein the one or more substitute items comprise a first substitute item and a second substitute item, wherein the first substitute item is defined by the real-time fulfillment data and the second substitute item is selected based on substitute preference data associated with the second computing device.

19. The non-transitory computer-readable medium of claim 17, wherein the at least one device is configured to:
receiving fulfillment completion data from the first computing device; and
in response to receiving the fulfillment completion data, transmitting second order update data to the second computing device, wherein the second order update data is configured to cause the second computing device to transition to a second interface that prevents modification of the order.

20. The non-transitory computer-readable medium of claim 17, wherein the interface generated in response to the order update data includes at least one interactive element configured to receive an input to define the substitute response, and wherein the substitute response is generated in response to receiving the input.
